(19) United States
(12) Patent Application Publication
(10) Pub. No.: US 2026/0262029 A1
(43) Pub. Date: Sep. 3, 2026

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Hao LIN, Dongguan (CN)

(21) Appl. No.: 19/654,141

(22) Filed: Apr. 21, 2026

Related U.S. Application Data
(63) Continuation of application No. PCT/CN2023/127175, filed on Oct. 27, 2023.

(51) Int. Cl. H04W 72/044; H04L 5/00; H04W 72/232

(52) U.S. Cl. CPC H04W 72/046; H04L 5/0053; H04W 72/232

(57) ABSTRACT

Provided is a wireless communication method including that: a terminal device receives first downlink signaling used for indicating beam information, the beam information including one or more of the following: a target beam in an active state, or a valid duration of the target beam. There are also provided a terminal device for performing this method, and a network device.

### CROSS-REFERENCE TO RELATED APPLICATION

This application is a continuation of International Patent Application No. PCT/CN2023/127175 filed on October 27, 2023, the content of which is hereby incorporated by reference in its entirety.

### BACKGROUND

Certain communication systems, such as a satellite communication system, support beam hopping technology. In the beam hopping scenario, how to flexibly control the beams by a network device is a problem that needs to be solved.

The present application relates to the technical field of communications, and in particular to a communication method, a terminal device and a network device.

The present application provides a wireless communication method, a terminal device and a network device. Various aspects of the present application will be described in detail below.

In a first aspect, there is provided a wireless communication method, including that: a terminal device receives first downlink signaling used for indicating beam information. Herein, the beam information includes one or more of the following: a target beam in an active state, or a valid duration of the target beam.

In a second aspect, there is provided a terminal device, including a processor and a memory. The memory is configured to store a program, and the processor is configured to invoke the program in the memory to cause the terminal device to perform the method according to the first aspect.

In a third aspect, there is provided a network device, including a processor and a memory. The memory is configured to store a program, and the processor is configured to invoke the program in the memory to cause the network device to: send to a terminal device first downlink signaling used for indicating beam information. The beam information includes one or more of the following: a target beam in an active state, or a valid duration of the target beam.

In the embodiments of the present application, whether a beam is activated and/or the valid duration of a beam is controlled based on the first downlink signaling, which improves the flexibility of beam control in a beam hopping scenario.

### BRIEF DESCRIPTION OF THE DRAWINGS

FIG. 1A is an exemplary diagram of a communication scenario applicable to embodiments of the present disclosure.

FIG. 1B is an exemplary diagram of another communication scenario applicable to embodiments of the present disclosure.

FIG. 1C is an exemplary diagram of yet another communication scenario applicable to embodiments of the present disclosure.

FIG. 2 is an exemplary diagram of still another communication scenario applicable to embodiments of the present disclosure.

FIG. 3 is an exemplary diagram of still another communication scenario applicable to embodiments of the present disclosure.

FIG. 4 is an exemplary diagram of still another communication scenario applicable to embodiments of the present disclosure.

FIG. 5 is an exemplary diagram of a beam hopping scenario.

FIG. 6 is a schematic flowchart of a communication method provided by an embodiment of the present application.

FIG. 7 is an exemplary diagram of implementation of a first downlink signaling provided by embodiments of the present application.

FIG. 8 is an exemplary diagram of implementation of first DCI provided by embodiments of the present application.

FIG. 9A is an exemplary diagram of the arrangement of time domain positions of a plurality of monitoring occasions provided by embodiments of the present application.

FIG. 9B is an exemplary diagram of the arrangement of time domain positions of a plurality of monitoring occasions provided by embodiments of the present application.

FIG. 10 is an exemplary diagram of determination of a start location of a valid duration provided by embodiments of the present application.

FIG. 11 is another exemplary diagram of determination of a start location of a valid duration provided by embodiments of the present application.

FIG. 12 is yet another exemplary diagram of determination of a start location of a valid duration provided by embodiments of the present application.

FIG. 13 is a schematic flowchart of a communication method provided by another embodiment of the present application.

FIG. 14 is a schematic structural diagram of a terminal device provided by embodiments of the present application.

FIG. 15 is a schematic structural diagram of a network device provided by embodiments of the present application.

FIG. 16 is a schematic structure diagram of an apparatus applicable to embodiments of the present application.

### DETAILED DESCRIPTION

### Communication system architecture

The technical solutions provided by the embodiments of the present application may be applied to various communication systems, such as a global system of mobile communication (GSM), a code division multiple access (CDMA) system, a wideband code division multiple access (WCDMA) system, a general packet radio service (GPRS) system, a long term evolution (LTE) system, an advanced long term evolution (LTE-A) system, a new radio (NR) system, an evolution system of the NR system, a LTE-based access to unlicensed spectrum (LTE-U) system on unlicensed spectrum, an NR-based access to unlicensed spectrum (NR-U) system, a non-terrestrial network (NTN) system, a universal mobile telecommunication system (UMTS), wireless local area networks (WLAN), wireless fidelity (Wi-Fi), a 5th-generation (5G) system, or another communication system, for example a future communication system such as a sixth-generation mobile communication system, for another example a satellite communication system.

Generally speaking, conventional communication systems support a limited number of connections and are easy to implement. However, with the development of communication technology, the mobile communication system will support not only conventional communication, but also support, for example, device to device (D2D) communication, machine to machine (M2M) communication, machine type communication (MTC), vehicle to vehicle (V2V) communication, or vehicle to everything (V2X) communication, and the like. The embodiments of the present application may also be applied to these communication systems.

The communication system in the embodiments of the present application may be applied to a carrier aggregation (CA) scenario, a dual connectivity (DC) scenario, or a standalone (SA) deployment scenario.

The communication system in the embodiments of the present application may be applied to an unlicensed spectrum, where the unlicensed spectrum may also be regarded as a shared spectrum. Alternatively, the communication system in the embodiments of the present application may also be applied to a licensed spectrum, where the licensed spectrum may also be regarded as a dedicated spectrum.

The embodiments of the present application may be applied to an NTN system or a terrestrial networks (TN) system. By way of example and not limitation, the NTN system includes an NR-based NTN system and an IoT-based NTN system.

Various embodiments are described in combination with a network device and a terminal device in the embodiments of the present application. The terminal device may refer to user equipment (UE), an access terminal, a subscriber unit, a subscriber station, a mobile station, a mobile station (MS), a mobile Terminal (MT), a remote station, a remote terminal, a mobile device, a user terminal, a terminal, a wireless communication device, a user agent, or a user device, and the like.

In the embodiments of the present application, the terminal device may be a STATION (ST), a cellular phone, a cordless phone, a session initiation protocol (SIP) telephone, a wireless local loop (WLL) station, a personal digital assistant (PDA) device, a handheld device with wireless communication function, a computing device or other processing devices connected to a wireless modem, an in-vehicle device, a wearable device, a terminal device in the next-generation system (for example, NR network) or a terminal device in the future evolved public land mobile network (PLMN) network, etc.

In the embodiments of the present application, the terminal device may be a device that provides voice and/or data connectivity to a user and may be used to connect people, objects, and machines, for example, a handheld device having a wireless connection function, a vehicle-mounted device, or the like. The terminal device in the embodiments of the present application may be a mobile phone, a Pad, a notebook computer, a handheld computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. Optionally, the terminal device may be used to act as a base station. For example, the terminal device may act as a scheduling entity that provides sidelink signals between the terminal devices in V2X or D2D, etc. For example, cellular telephones and automobiles communicate with each other using sidelink signals. Communication between cellular phones and smart home devices does not need relaying communication signals through base stations.

In the embodiments of the present application, the terminal device may be deployed on land, including indoor or outdoor, handheld, wearable, or vehicle-mounted. It may also be deployed on the water (such as ships, etc.), or in the air (e.g. on aircraft, balloons and satellites, etc.).

In the embodiments of the present application, the terminal device may be a mobile phone, a pad, a computer with a wireless transceiver function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, or the like. The terminal device involved in the embodiments of the present application may refer to a terminal, a user equipment (UE), an access terminal device, a in-vehicle terminal, a industrial control device, a UE unit, a UE station, a mobile station, a mobile station, a remote station, a remote terminal, a mobile device, UE, a wireless communication device, a UE agent, or a UE device, etc. The terminal device may also be fixed or mobile.

As an example and not limitation, in an embodiment of the present application, the terminal device may also be a wearable device. Wearable devices, also referred to as wearable smart devices, represent a general term for intelligently designed items developed by applying wearable technology to everyday wearable. Examples include glasses, gloves, watches, clothing, and shoes. The wearable device is a portable device that is worn directly on the body or integrated into the user's clothes or accessories. Wearable devices are not only a kind of hardware devices, but also realize powerful functions through software support, data interaction and cloud interaction. Generalized wearable smart devices include both fully-featured and larger-sized devices that may operate independently or partially independently without relying on a smartphone, such as smart watches or smart glasses, as well as devices focused on specific types of application functions, which require pairing with other devices like smartphones, such as various smart bands or smart jewelry designed for monitoring physiological signs.

The network device in the embodiments of the present application may be a device that communicates with terminal devices, and the network device may also be referred to as an access network device or a radio access network device. For example, the network device may be a base station. The network device in the embodiments of the present application may refer to a radio access network (RAN) node (or device) that connects the terminal devices to the wireless network. The base station may broadly encompass or be interchanged with the following various designations, such as a NodeB, an evolved NodeB (eNB), a next generation NodeB (gNB), a relay station, an access point, a transmitting and receiving point (TRP), a transmitting point (TP), a master station (MeNB), a secondary station (SeNB), a multi-standard radio (MSR) node, a home base station, a network controller, an access point (AP), a transmission node, a transceiver node, a base band unit (BBU), a remote radio unit (RRU), an active antenna unit (AAU), a remote radio head (RRH), a central unit (CU), a distributed unit (DU), a location node, and the like. The base station may be a macro base station, a micro base station, a relay node, a donor node, or the like, or a combination thereof. The base station may also refer to a communication module, a modem, or a chip for disposal within the aforementioned devices or apparatuses. The base station may also be a mobile switching center, as well as a device that undergoes base station functions in D2D communication, vehicle-to-everything (V2X) communication, machine-to-Machine (M2M) communication, a network-side device in 6G network, and a device that undergoes base station functions in a future communication system, or the like. The base station may support networks of the same or different access technologies. The embodiments of the present application do not limit the specific technology and the specific device form adopted by the network device.

The base station may also be fixed or mobile. For example, a helicopter or drone may be configured to act as a mobile base station, and one or more cells may move according to the location of the mobile base station. In other examples, a helicopter or drone may be configured as a device communicating with another base station.

In some deployments, the network device in the embodiments of the present application may refer to a CU or a DU, or the network device includes a CU and a DU. The gNB may also include an AAU.

The network device and terminal device may be deployed on land, including indoor or outdoor, handheld, wearable, or vehicle-mounted, or may also be deployed on the water, or deployed on aircraft, balloons and satellites in the air. In the embodiments of the present application, the scenario in which the network device and the terminal device are located is not limited.

As an example and not limitation, in an embodiment of the present application, the network device may have mobility characteristics, for example, the network device may be a mobile device. In some embodiments of the present application, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments of the present application, the network device may also be a base station disposed on land, on the water, or the like.

In the embodiments of the present application, the network device may provide services for a cell, and the terminal device communicates with the network device through transmission resources (for example, frequency domain resources or spectrum resources) used by the cell. The cell may be a cell corresponding to the network device (for example, a base station), and the cell may belong to a macro base station or a base station corresponding to a small cell. Here, the small cell may include a metro cell, a micro cell, a pico cell, a femto cell, etc. These small cells have the characteristics of small coverage and low transmission power, and are suitable for providing high-speed data transmission services.

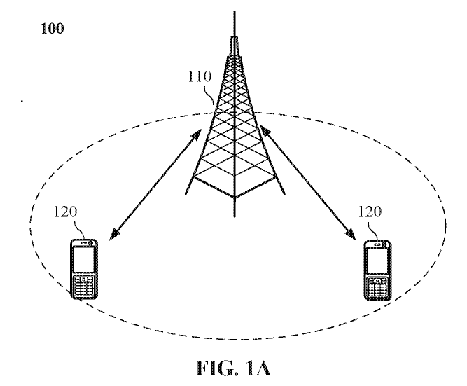

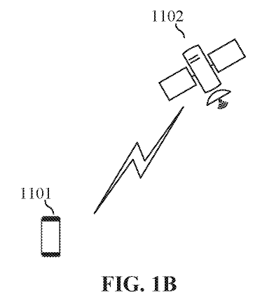

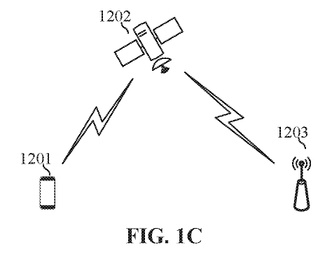

As an example, FIG. 1 is a schematic diagram of architecture of a communication system provided by an embodiment of the present application. As shown in FIG. 1A, the communication system 100 may include a network device 110. The network device 110 may be a device that communicates with terminal devices 120 (or referred to as communication terminals, or terminals). The network device 110 may provide communication coverage for a particular geographic area and may communicate with terminal devices located within the coverage area.

FIG. 1A exemplarily illustrates one network device and two terminal devices. In some embodiments of the present application, the communication system 100 may include multiple network devices and another number of terminal devices may be included within the coverage of each network device, which is not limited in the embodiments of the present application.

As an example, FIG. 1B is a schematic diagram of architecture of another communication system provided by an embodiment of the present application. Referring to FIG. 1B, a terminal device 1101 and a satellite 1102 are included, and wireless communication may be performed between the terminal device 1101 and the satellite 1102. The network formed between the terminal device 1101 and the satellite 1102 may also be referred to as an NTN. In the architecture of the communication system illustrated in FIG. 1B, the satellite 1102 may have the functions of a base station, and the terminal device 1101 and the satellite 1102 may communicate directly. Under the system architecture, the satellite 1102 may be referred to as a network device. In some embodiments of the present application, the communication system may include multiple network devices 1102, and another number of terminal devices may be included within the coverage of each network device 1102, which is not limited in the embodiments of the present application.

As an example, FIG. 1C is a schematic diagram of architecture of another communication system provided by an embodiment of the present application. Referring to FIG. 1C, a terminal device 1201, a satellite 1102 and a base station 1203 are included, and wireless communication may be performed among the terminal device 1201, the satellite 1102 and the base station 1203. The network formed between the terminal device 1201, the satellite 1102 and the base station 1203 may also be referred to as an NTN. In the architecture of the communication system illustrated in FIG. 1C, the satellite 1102 may not have the functions of a base station, and the communication between the terminal device 1201 and the base station 1203 may need the relay via the satellite 1202. Under the system architecture, the base station 1203 may be referred to as a network device. In some embodiments of the present application, the communication system may include multiple network devices 1203, and another number of terminal devices may be included within the coverage of each network device 1203, which is not limited in the embodiments of the present application.

It should be noted that FIGS. 1A to 1C only illustrate systems to which the present application is applicable in the form of examples, and the method described in the embodiment of the present application may also be applied to other systems, such as a 5G communication system, an LTE communication system, and the like, which are not limited in the embodiments of the present application.

In some embodiments of the present application, the wireless communication system shown in FIGS. 1A to 1C may also include other network entities, such as a mobility management entity (MME), an access and mobility management function (AMF), etc., which are not limited in the embodiments of the present application.

It should be understood that a device having a communication function in the network/system in the embodiments of the present application may be referred to as a communication device. Taking the communication system 100 illustrated in FIG. 1A as an example, the communication device may include a network device 110 and terminal devices 120 having a communication function, and the network device 110 and the terminal device 120 may be specific devices as described above and will not be repeated here. The communication device may also include other devices in the communication system 100, for example other network entities such as a network controller and a mobility management entity, which are not limited in the embodiments of the present application.

It should be understood that the "indication" mentioned in the embodiments of the present application may be a direct indication, an indirect indication, or may represent an associated relationship. For example, A indicating B may mean that A directly indicates B, for example, B may be acquired by A. It may also mean that A indicates B indirectly, for example A indicates C, and B may be acquired by C. It may also mean that there is an association relationship between A and B.

In the description of the embodiments of the present application, the term "correspondence" may indicate that there is a direct correspondence or indirect correspondence between the two, or indicate that there is a correlation relationship between the two, or indicate a relationship between indicating and being indicated, configuring and being configured, or the like.

The "configure" in the embodiments of the present application may include being configured using at least one of a system information, a radio resource control (RRC) signaling, or a media access control control element (MAC CE).

In some embodiments of the present application, the “predefined” or “preset” may be implemented by pre-storing corresponding codes, tables, or other manners that may be used to indicate relevant information in devices (e.g., including terminal devices and network devices), the specific implementation of which is not limited by the present disclosure. For example, predefined may refer to what is defined in the protocol.

In some embodiments of the present application, the "protocol" may refer to a standard protocol in communication field, including, for example, an LTE protocol, an NR protocol, and related protocols applied in future communication systems, which are not limited in the present application.

At present, the 3rd generation partnership project (3GPP) is studying NTN technology. NTN generally uses satellite communication to provide communication services to ground users. Compared with terrestrial cellular communication, satellite communication offers many unique advantages.

First of all, satellite communication is not restricted by the user's geographical area. For example, general terrestrial communication network cannot cover areas such as oceans, mountains, and deserts where network devices cannot be installed. Or, the terrestrial communication network may not cover certain sparsely populated areas. For satellite communication, since a satellite can cover a large ground area and the satellite can orbit around the earth, theoretically, every corner of the earth can be covered by the satellite communication network.

Secondly, satellite communication has great social values. Satellite communication can cover remote mountainous areas, poor and backward countries or regions at a low cost, so that people in these areas can enjoy advanced voice communication and mobile Internet technology. From this perspective, satellite communication is conducive to narrowing the digital divide with developed regions and promoting the development of these regions.

Thirdly, satellite communication has the advantage of long distance, and the increase of communication distance does not significantly increase the cost of communication.

Finally, satellite communication has high stability and is not affected by natural disasters.

The communication satellites, according to different orbital altitudes, may be classified into low earth orbit (LEO) satellite, medium earth orbit (MEO) satellite, geostationary earth orbit (GEO) satellite, high elliptical orbit (HEO) satellite, or the like. At present, LEO satellite and GEO satellite are mainly studied.

The LEO satellite has an altitude generally ranging from 500km to 1500km and a corresponding orbital period of about 1.5 hours to 2 hours. For LEO satellites, the signal propagation delay of single-hop communication between users is generally less than 20ms. The maximum satellite visual time of a LEO satellite is about 20 minutes. The LEO satellite has the advantages of short signal propagation distance, less link loss, and low transmission power requirements for users' terminal devices.

The GEO satellite has an orbital altitude of 35786 km. The GEO satellite rotates around the earth for a period of 24 hours. For GEO satellites, the signal propagation delay of single-hop communication between users is generally about 250ms.

In order to ensure satellite coverage and improve the system capacity of the entire satellite communication system, satellites usually use multiple beams to cover the ground area. Therefore, a satellite may form dozens or even hundreds of beams to cover the ground area, and one satellite beam may cover a ground area with a diameter of tens to hundreds of kilometers.

Currently, NTN system includes NR-NTN system and internet of things (IoT)-NTN system.

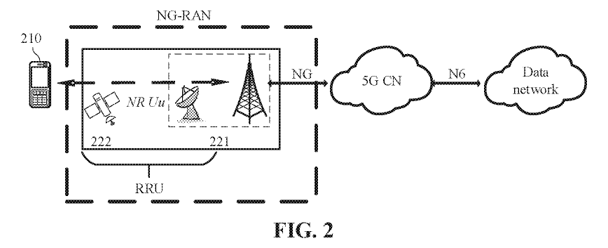

At present, 3GPP considers two types of satellites, one is those with transparent payloads, and the other is those with regenerative payloads. The network architecture including a transparent payload satellite and the network architecture including regenerative payload satellite are described below in conjunction with FIGS. 2 to 4, respectively.

In the satellite network architecture shown in FIGS. 2 to 4, the satellite network architecture may include a terminal device 210, a satellite node 222, and a ground receiving station 221 (referred to as a "ground station" for short). There is wireless communication between the terminal device 210 and the satellite node 222, and the terminal device 210 may transmit data to the satellite node 222 over a link between the terminal device 210 and the satellite node 222. For example, it may be sent to the satellite node 222 over a service link. Accordingly, after receiving the data, the satellite node 222 may transmit the data to the ground receiving station 221 via a link between the satellite node 222 and the ground receiving station 221. For example, it may be delivered to the ground receiving station 221 over a wireless link (for example, a feeder link). Accordingly, after receiving the data from the satellite node 222, the ground receiving station 221 transmits the data to a core network (i.e., data network), and then the core network processes the data, for example, performing data interaction with other terminals. It can be understood that the service link herein refers to a link between the terminal device 210 and the satellite node 222, and the feeder link refers to a link between the satellite node 222 and the ground receiving station 221. In other possible embodiments, the link between the terminal device and the satellite node, and/or the link between the satellite node and the ground receiving station may also be represented by other terms, which are not limited in the present application.

The satellite node 222 described above may be divided into three types, and the first type of satellite node is used only for forwarding, that is, only has a transparent forwarding function. In some implementations, such satellite node may provide only one or more of a radio frequency filtering function, a frequency conversion function, or a power amplification function. For this type of satellite node, the received signal from a terminal device is amplified and then sent to the ground receiving station without any processing on the satellite node, as shown in FIG. 2. The terminal device and the satellite node may communicate via an NR-Uu interface, and the satellite node and the ground receiving station (which may, for example, include NTN Remote Radio Unit (RRU) and gNB) may communicate via an NR-Uu interface, the ground receiving station and the 5G core network (5G CN) may communicate via N1/2/3 interface, and the 5G CN and the data network may communicate via an N6 interface.

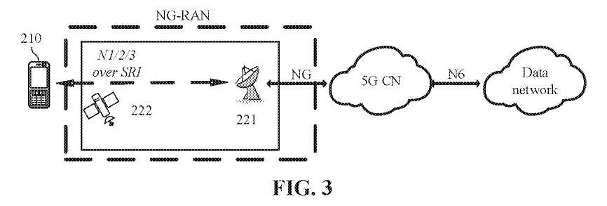

The second type of satellite node possesses full processing functions of a base station. The satellite node is a base station for ground terminal devices. The communication between the satellite node and the terminal devices is basically consistent with normal 5G communication, as shown in FIG. 3. In some implementations, such satellite node may also provide one or more of the following functions: demodulation, decoding, routing, conversion, encoding, and modulation. The terminal device and the satellite node may communicate via an NR-Uu interface, and the satellite node and the ground receiving station may communicate via a satellite radio interface (SRI), which may be used to send interface messages between the satellite node and the 5G CN (for example, N2/N3 interface message). The ground receiving station and the 5G CN may communicate via an N1/2/3 interface, and the 5G CN and the data network may communicate via an N6 interface.

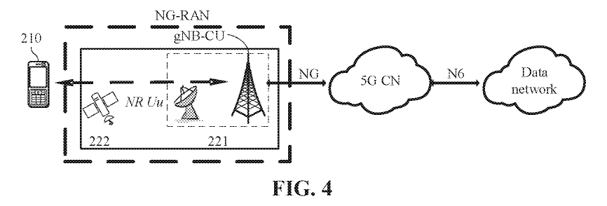

The third type of satellite node possesses processing capabilities of a DU. The satellite node is a DU for ground terminal devices. The communication between the satellite node and the terminal devices is basically consistent with the communication between the terminal devices and the DU in normal 5G terrestrial communication system, as shown in FIG. 4. The terminal device and the satellite node may communicate via the NR-Uu interface, the satellite node and the ground receiving station (for example, gNB-CU) may communicate via the SRI interface, which may transmit F1 interface messages between the satellite and the ground receiving station. The ground receiving station and the 5G CN may communicate via the N1/2/3 interface, and the 5G CN and the data network may communicate via the N6 interface.

In satellite communication, depending on the satellite deployments and based on the required signal to noise (SNR) at UE level of physical channels supported for NTN system, a satellite may have limited transmission power and processing bandwidth. Therefore, a satellite may only serve part of the potential satellite coverage area at a time. In other words, the satellite may be unable to have all its beams be active with the nominal equivalent isotropic radiated power (EIRP) density per beam at a given time due to limited power and limited feeder link bandwidth. Hence, downlink (DL) satellite beam hopping is proposed in related art.

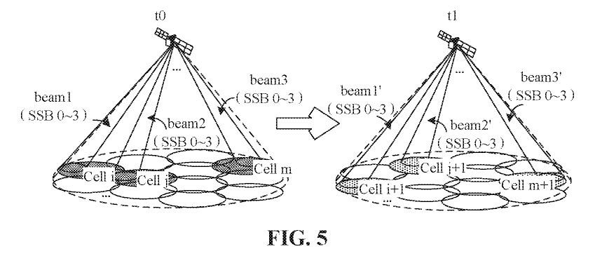

FIG. 5 illustrates an example of the implementation process of beam hopping. Referring to FIG. 5, a satellite may serve a set of beams (i.e., beam 1, beam 2, and beam 3 in FIG. 5, each beam in the set of beams may be referred to as an active beam or an active satellite beam) at time t0. The coverage on earth corresponding to each beam in the set of beams may be considered as a cell coverage. Hence, multiple active beams may be located in multiple active cells correspondingly. Then, at time t1, the set of beams will become inactive, and at this time, the satellite may activate another set of beams (i.e., beam 1’, beam 2’ and beam 3’ in FIG. 5). The above process is the beam hopping process in a multi-beam system. As can be seen from the above description, the beam hopping process may cause a cell to switch from an active state to an inactive state.

In the beam hopping scenario, a network device may need a flexible manner to control the beam activation/deactivation. In view of this problem, embodiments of the present application will be described in detail below.

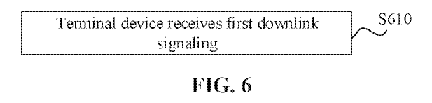

FIG. 6 is a schematic flowchart of a communication method provided by an embodiment of the present application. The method in FIG. 6 may be performed by a terminal device. The terminal device may be, for example, a terminal device that supports NTN. It should be understood that the state of the terminal device is not specifically limited in the embodiments of the present application, and it may be a terminal device in a connected state, a terminal device in an idle state, or a terminal device in an inactive state.

Referring to FIG. 6, in operation S610, the terminal device receives first downlink signaling used for indicating beam information (or active beam information). The beam information includes one or more of the following: a target beam in an active state or a valid duration of a target beam.

It should be understood that the target beam in the active state may also be referred to as an active beam or an activated beam direction. The target beam may include one beam or a plurality of beams. "In an active state" may also be referred to as or replaced with "in a valid state" or "in a usable state". It should also be understood that the valid duration of the target beam refers to a duration in which the target beam is in an active state, in a valid state, or in a usable state. The target beam mentioned herein may be a cell-level beam. For example, one cell may correspond to one beam.

The first downlink signaling may be a dynamic signaling. For example, the first downlink signaling may be downlink control information (DCI). For another example, the first downlink signaling may be a medium access control control element (MAC CE).

In some implementations, the valid duration of the target beam may be determined based on a transmission duration of the first downlink signaling (such as a time duration in which the terminal device receives the first downlink signaling) and/or an offset (which may be in unit of symbols or slots). For example, a reference moment may be determined based on the transmission duration of the first downlink signaling, and then an offset may be added to the reference moment, so as to determine the start location of the valid duration of the target beam. The reference time may be, for example, a start location or an end location of the transmission duration of the first downlink signaling, or may be a start location or an end location of a time slot in which the first downlink signaling is located.

In some implementations, the above offset may be determined based on one or more of the following: capability of the terminal device, predefined information, or configuration information from a network device. The predefined information may be, for example, one or more predefined values, which may correspond to subcarrier spacing.

In some implementations, the value of the valid duration may belong to a set of candidate values. The set of candidate values may be determined based on the configuration information from the network device. For example, the network device may configure the set of candidate values using RRC signaling and/or MAC CE.

In some implementations, the value of the valid duration may be in unit of slots or symbols.

After receiving the first downlink signaling, in some implementations, the terminal device may determine a target beam in an active state. Then, the terminal device may adjust the transmission and/or reception operation according to the target beam.

The implementations of the first downlink signaling are described in detail below by respectively taking the first downlink signaling as DCI and MAC CE as examples.

### Implementation 1: the first downlink signaling is a first DCI (or a first DCI format)

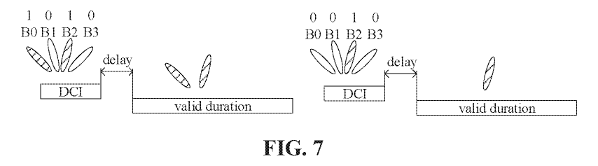

The first DCI may indicate an index of a target beam in an active state. The index of the target beam may be associated with a synchronization signal block (SSB) index or a channel state information reference signal (CSI-RS) resource index. Taking frequency range 1 (FR1) as an example, there are four SSB indexes in FR1, i.e. SSB0~SSB3. The first DCI format may contain an indication field composed of 4 bits. The indication field may indicate the target beam using a bitmap fashion. Exemplarily, as shown in FIG. 7, the four bits (denoted by B0, B1, B2, B3, respectively) correspond to four SSB indexes. In the four bits, the most significant bit (MSB) represents the lowest SSB index and the least significant bit (LSB) represents the highest SSB index. If the value of one of the four bits is "1", it indicates "active", and if the value of one of the four bits is "0", it indicates "inactive". In an example on the left side of FIG. 7, the bits corresponding to SSB0 and SSB2 are 1, and the bits corresponding to SSB1 and SSB3 are 0. Thus, according to the indication of the bitmap, the terminal device may determine that during a valid duration, beams associated with SSB0 and SSB2 are active and the remaining beams are inactive. In an example on the right side of FIG. 7, only the bit corresponding to SSB2 is 1, and the bits corresponding to SSB0, SSB1, and SSB3 are all 0. Thus, according to the indication of the bitmap, the terminal device may determine that during a valid duration, the beam associated with SSB2 is active and the remaining beams are inactive. It is to be noted that the number of bits in the bitmap may be determined not only based on the total SSB indexes, but also based on the frequency range or spectrum access mode.

In addition to indicating the target beam in the active state, the first DCI may also indicate a valid duration of the target beam. For example, the first DCI may contain an indication field used for indicating a valid duration. The indication field indicates a value of the valid duration from a set of candidate values. The candidate values in the valid duration may be determined based on the configuration information from the network device. For example, the network device may configure the candidate values through RRC signaling and/or MAC CE. Additionally, the value of the valid duration may be in unit of slots or symbols.

In some implementations, the first DCI is a UE-specific DCI.

In some implementations, the first DCI is a group common DCI. Or, a PDCCH carrying the first DCI is a group common PDCCH. Or, a PDCCH carrying the first DCI is transmitted in a common search space with type 3.

In some implementations, the first DCI is scrambled with a dedicated RNTI.

In some implementations, the first DCI may include one or more information fields. The one or more information fields may have one-to-one correspondence with one or more cells. Each of the one or more information fields may be used to indicate beam information of a cell corresponding to each information field (which may include an active beam of the cell corresponding to each information domain and/or a valid duration of the active beam).

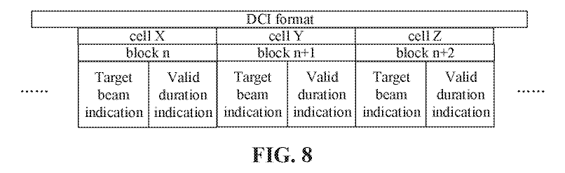

For example, referring to FIG. 8, if a terminal device is associated with cell X, the network device may configure the terminal device to monitor the first DCI and provide the terminal device with the first bit location of block n (which may include N bits, N being a positive integer greater than or equal to 1). After receiving the first DCI, the terminal device may read N bits from the first bit location of the block N (where the number of bits included in different blocks may be the same), to obtain the beam information of the cell X.

The monitoring manner for the first DCI is not limited in the embodiments of the present application. For example, the terminal device may monitor the first DCI over multiple monitoring occasions (MOs). Further, in some implementations, the multiple MOs are associated with multiple transmission configuration indication (TCI) states. For example, the multiple MOs include a first MO and a second MO, where the first MO is associated with a first TCI state, and the second MO is associated with a second TCI state.

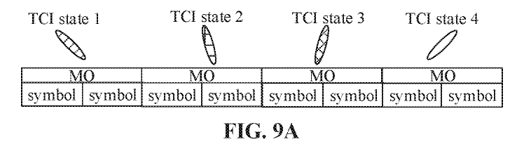

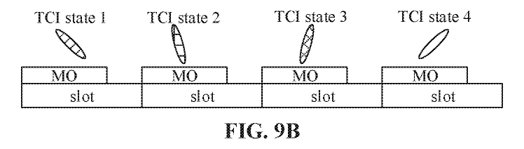

In some implementations, symbols corresponding to the multiple MOs are consecutive symbols, as shown in FIG. 9A.

In some implementations, slots corresponding to the multiple MOs are consecutive slots, as shown in FIG. 9B.

The following provides a detailed example of how to determine the start location of the valid duration.

In some implementations, the start location of the valid duration may be determined based on one or more of the following: a transmission duration of the first DCI (for example, a time duration in which the terminal device receives the first DCI), or a first offset.

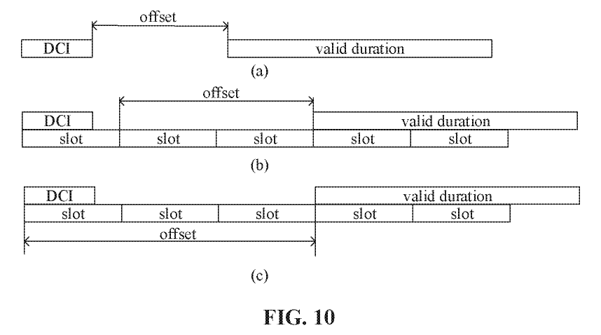

For example, the start location of the valid duration is determined based on a sum of an end location of the first DCI and the first offset. As an example, the start location of the valid duration is determined based on a sum of an end location of the transmission duration of the first DCI and the first offset (referring to (a) in FIG. 10). In this case, the first offset may be in unit of symbols.

For another example, the start location of the valid duration is determined based on a sum of the start location of the first DCI and the first offset. As an example, the start location of the valid duration is a moment corresponding to a sum of a start of the transmission duration of the first DCI and the first offset. In this case, the first offset may be in unit of slots, or in unit of symbols.

In some implementations, the start location of the valid duration is determined based on the first slot and/or the first offset. The first slot is determined based on the transmission duration of the first DCI. For example, the first slot corresponds to the transmission duration of the first DCI, that is, the transmission duration of the first DCI is located within the first slot.

For example, the start location of the valid duration is determined based on a sum of an end location of the first slot and the first offset. As an example, the start location of the valid duration is a moment corresponding to a sum of the end of the first slot and the first offset (referring to (b) in FIG. 10).

For another example, the start location of the valid duration is determined based on a sum of the start location of the first slot and the first offset. As an example, the start location of the valid duration is a moment corresponding to a sum of the start of the first slot and the first offset (referring to (c) in FIG. 10).

If the start location of the valid duration is determined based on the first slot and the first offset, in some implementations, the first offset may be in unit of slots.

The value of the first offset may be determined in a variety of ways. For example, the value of the first offset may be determined based on one or more of the following: capability of the terminal device, a predefined value, or configuration information from a network device. The predefined value may correspond to a subcarrier spacing.

### Implementation 2: the first downlink signaling is first MAC CE

In some implementations, if the first downlink signaling is a first MAC CE, then the target beam in the beam information may be represented in a manner similar to Implementation 1 (e.g., represented in a bitmap manner), or the target beam in the beam information may also be represented using an SSB index or a CSI-RS resource identifier.

In some implementations, if the first downlink signaling is a first MAC CE, then the first MAC CE may indicate one or more of a cell identity and/or a bandwidth part (BWP) identifier, in addition to the aforementioned beam information.

If the first downlink signaling is a first MAC CE, the start location of the valid duration of the target beam may be related to transmission of and/or feedback for the first MAC CE. The following provides detailed examples of how to determine the start location of the valid duration of the target beam

In some implementations, the start location of the valid duration of the target beam may be determined based on one or more of the following: a transmission duration of the first MAC CE (e.g., a time when the terminal device receives the first MAC CE), a transmission duration of feedback information for the first MAC CE (hybrid automatic repeat reQuest-acknowledge (HARQ-ACK) information) (e.g., a time when the terminal device sends the feedback information), or a second offset.

### Example 1 (applicable to a scenario in which the terminal device sends feedback information corresponding to the first MAC CE):

The start location of the valid duration of the target beam is determined based on the first downlink (DL) slot and/or the second offset (which may be determined based on system information). The first DL slot may be determined based on the first uplink (UL) slot (for example, a slot number of the first DL slot corresponds to a slot number of the first UL slot, that is, the first DL slot has the same slot number as the first UL slot). The first UL slot corresponds to the transmission duration of the feedback information, that is, the transmission duration of the feedback information is located within the first UL slot (i.e., the terminal device sends the feedback information in the first UL slot).

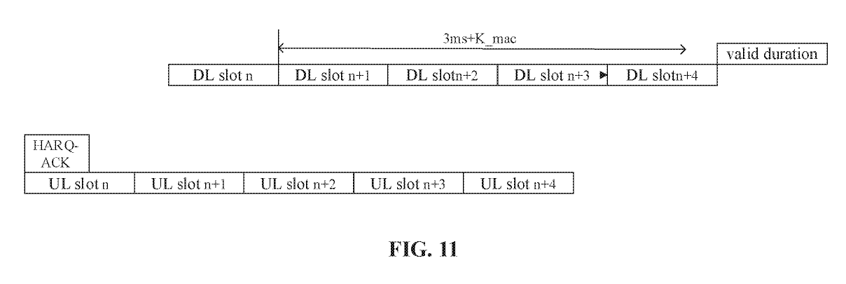

Further, the start location of the valid duration is determined based on a sum of the first DL slot and the second offset. For example, referring to FIG. 11, the start location of the valid duration of the target beam starts from the first DL slot n+3ms+K_mac, where K_mac is the second offset, and K_mac may be one or more slots provided by system information.

Example 2 (applicable to a scenario in which the terminal device sends or not sends feedback information corresponding to the first MAC CE):

The start location of the valid duration of the target beam is determined based on the second downlink (DL) slot and/or the second offset. The second DL slot corresponds to the transmission duration of the first MAC CE, that is, the first MAC CE is transmitted in the second DL slot (i.e., the terminal device receives the first MAC CE in the second DL slot).

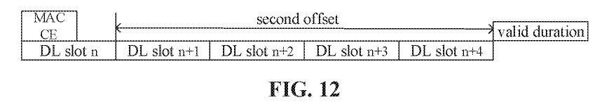

For example, referring to FIG. 12, the start location of the valid duration is determined based on a sum of the second DL slot and the second offset. As an example, the start location of the valid duration of the target beam is equal to a moment corresponding to a sum of the second DL slot (which may be from a start location or an end location of the second DL slot) and the second offset.

In the Example 2, the second offset may be determined based on one or more of predefined information, configuration information from the network device, or capability of the terminal device.

The implementations of the first downlink signaling are described in detail above. The behavior of the terminal device after receiving the first downlink signaling is not limited in the embodiments of the present application. The possible impact of the introduction of the first downlink signaling on the behavior of the terminal device will be described in detail as follows.

### Regarding the monitoring of PDCCH in CORESET

The terminal device may be configured with one or more CORESETs (which may include CORESET0). One CORESET may be configured with one or more TCI states. The TCI state may include quasi co-location (QCL) information. The QCL information may contain an SSB index or a CSI-RS resource index. If there are two downlink transmissions and the terminal device may use a same spatial domain filter to receive the two downlink transmissions, then the two downlink transmissions may be called being QCL’ed. In some implementations, a TCI state may be associated with a beam. For example, a TCI state may be associated with an SSB index or a CSI-RS resource index. Thus, if a CORESET is configured with a TCI state, and the TCI state is associated with a piece of beam information, it means that the CORESET is configured with the beam information associated with the TCI state, so that the terminal device knows which spatial domain filter is to use for receiving the PDCCH in the CORESET. If a CORESET is configured with multiple TCI states, and the multiple TCI states are associated with multiple beam information, it represents that the CORESET is configured with multiple beam information associated with the multiple TCI states, and thus the terminal device may receive the PDCCH in the CORESET from different beam directions (or different spatial domain filters).

Therefore, in some implementations, the terminal device may determine whether to monitor a PDCCH in the first CORESET during the valid duration, according to a TCI state configured for a first CORESET (which may be any one of the CORESETs configured for the terminal device) and/or the target beam. For example, the terminal device may determine whether to monitor the PDCCH in the first CORESET during the valid duration according to an association relationship between the TCI state configured for the first CORESET and the target beam.

Hereinafter, how the terminal device determines whether to monitor the PDCCH in the first CORESET during the active duration will be described in more detail with reference to specific examples. It should be noted that the following examples are merely to help those skilled in the art understand the embodiments of the present application, and are not intended to limit the embodiments of the present application to the specific numerical values or specific scenarios illustrated exemplarily. It will be apparent to those skilled in the art that various equivalent modifications or changes may be made based on the following examples, and such modifications or changes shall also fall within the scope of the embodiments of the present application. It should also be understood that the reference to "a TCI state configured for the CORESET is associated with the target beam" in the following examples means that: QCL information contained in the TCI state configured for the CORESET is associated with the target beam; or in other words, a beam associated with the QCL information is the same as the target beam. Similarly, the reference to "a TCI state configured for the CORESET is not associated with the target beam" in any embodiment of the present application means that: QCL information contained in the TCI state configured for the CORESET is not associated with the target beam; or in other words, a beam associated with the QCL information is different from the target beam.

### Example 1:

If TCI states configured for the first CORESET are all associated with the target beam, the terminal device will monitor a PDCCH in the first CORESET during the valid duration; and/or if at least one of the TCI states configured for the first CORESET is not associated with the target beam, the terminal device will not monitor the PDCCH in the first CORESET.

For example, the terminal device is configured with a first CORESET, and the first CORESET is configured with a TCI state. The TCI state includes QCL information, and the QCL information contains SSB index 0. The terminal device receives first downlink signaling (which may be the first DCI or the first MAC CE mentioned above), and the first downlink signaling indicates that a beam corresponding to the SSB index 0 is in an active state in the valid duration. In this case, the terminal device will monitor the PDCCH in the first CORESET during the valid duration. However, if the first downlink signaling indicates that the beam corresponding to the SSB index 0 is in an inactive state in the valid duration, the terminal device will not monitor the PDCCH in the first CORESET during the valid duration.

### Example 2:

If at least one of the TCI states configured for the first CORESET is associated with the target beam, the terminal device will monitor the PDCCH in the first CORESET during the valid duration; and/or if the TCI states configured for the first CORESET are all not associated with the target beam, the terminal devicewill not monitor the PDCCH in the first CORESET.

For example, the terminal device is configured with a first CORESET, and the first CORESET is configured with two TCI states. These two TCI state both include QCL information, which are respectively QCL information 1 and QCL information 2. The QCL information 1 contain SSB index 0, and the QCL information 2 contain SSB index 1. The terminal device receives first downlink signaling (which may be the first DCI or the first MAC CE mentioned above), and the first downlink signaling indicates that a beam corresponding to the SSB index 0 is in an active state in the valid duration, then the terminal device will monitor the PDCCH in the first CORESET during the valid duration. However, if the QCL information 1 and the QCL information 2 respectively contain the SSB index 1 and the SSB index 2, the terminal device will not monitor the PDCCH in the first CORESET during the valid duration because neither a beam corresponding to the SSB index 1 nor a beam corresponding to the SSB index 2 is in an active state.

### Example 3:

If a first TCI state configured for the first CORESET is associated with the target beam, the terminal device will monitor a PDCCH in the first CORESET during the valid duration; and/or if the first TCI state configured for the first CORESET is not associated with the target beam, the terminal device will not monitor the PDCCH in the first CORESET during the valid duration. The first TCI state is a TCI state that is active among the TCI states configured for the first CORESET (where the TCI state that is active among the TCI states configured for the first CORESET may for example be configured according to configuration information from the network device).

For example, the first CORESET is configured with TCI state 1 and TCI state 2. The TCI state 1 is associated with SSB index 0 (e.g., QCL information in TCI state 1 contains SSB index 0), and the TCI state 2 is associated with SSB index 1 (e.g., QCL information in TCI state 2 contains SSB index 1). The network device indicates that the TCI state 1 is active using the configuration information. However, if the first downlink signaling received by the terminal device indicates that a beam corresponding to SSB index 0 is in an inactive state in the valid duration, then the terminal device will not monitor the PDCCH in the first CORESET during the valid duration.

In some implementations, the terminal device may determine, according to the target beam, a TCI state that is active among the TCI states configured for the first CORESET. For example, the first CORESET is configured with a first TCI state and a second TCI state, and the first TCI state is active. If the first TCI state is not associated with the target beam and the second TCI state is associated with the target beam, the terminal device may determine the second TCI state as the TCI state that is active. Further, in some implementations, the terminal device may monitor the PDCCH in the first CORESET during the valid duration.

As an example, the first CORESET is configured with TCI state 1 and TCI state 2. The TCI state 1 is associated with SSB index 0 (e.g., QCL information in TCI state 1 contains SSB index 0), and the TCI state 2 is associated with SSB index 1 (e.g., QCL information in TCI state 2 contains SSB index 1). The network device indicates that the TCI state 1 is active using the configuration information. Further, the terminal device receives first downlink signaling, and the first downlink signaling indicates that a beam corresponding to SSB index 1 is in an active state and a beam corresponding to the SSB index 0 is in an inactive state. In this case, the terminal device may assume that the active TCI state for the first CORESET is changed from the TCI state 1 to the TCI state 2. Then, the terminal device may monitor the PDCCH in the first CORESET during the valid duration.

Further, in some implementations, if the TCI state configured for the first CORESET includes multiple TCI states associated with the target beam (provided that the first TCI state is still active and is not associated with the target beam), then the above-mentioned second TCI state may be determined from the multiple TCI states. For example, the second TCI state may be one of the following: a TCI state with the smallest index among the multiple TCI states, or a TCI state with the largest index, among the multiple TCI states.

For example, the first CORESET is configured with TCI state 1, TCI state 2, and TCI state 3, where TCI state 1 is associated with SSB index 0 (for example, QCL information in TCI state 1 includes SSB index 0), TCI state 2 is associated with SSB index 1 (for example, QCL information in TCI state 2 includes SSB index 1), and TCI state 3 is associated with SSB index 2 (for example, QCL information in TCI state 3 includes SSB index 2). The network device indicates that the TCI state 1 is active using the configuration information. Further, the terminal device receives first downlink signaling, and the first downlink signaling indicates that beams corresponding to SSB index 1 and SSB index 2 are in an active state, and a beam corresponding to SSB index 0 is in an inactive state. In this case, the terminal device may change the TCI state with the smallest index, i.e., a TCI state corresponding to the TCI index 2, to the active state; or the terminal device may change the TCI state with the largest index, that is, the TCI state corresponding to the TCI index 3, to the active state.

In some implementations, if a TCI state configured for CORESET0 is not associated with the target beam, the terminal device will not monitor PDCCH in the first CORESET0 during the valid duration. The present implementation does not limit how to determine the TCI state of the CORESET0, for example, the TCI state of the CORESET0 may be QCL’ed with a SSB index determined in an initial access procedure (such as a random access channel (RACH) procedure).

In some implementations, if the TCI state configured for the CORESET0 is not associated with the target beam, the terminal device determines a TCI state corresponding to the CORESET0 according to the target beam. For example, if the target beam includes one beam, the terminal device determines that the CORESET0 corresponds to a third TCI state, where the third TCI state is associated with the target beam. For another example, if the target beam includes multiple beams, the terminal device determines that the CORESET0 corresponds to a fourth TCI state, where the fourth TCI state is associated with at least one of the multiple beams.

In some implementations, during the valid duration, the terminal device is not expected to receive first indication information. The first indication information is used for configuring a TCI state corresponding to a first CORESET configured for the terminal device as a TCI state not associated with the target beam.

Regarding other signals except PDCCH

In some implementations, the terminal device may receive the first physical downlink shared channel (PDSCH) during the valid duration. The first PDSCH may be scheduled using a second DCI, and the second DCI may indicate a fourth TCI state, where the fourth TCI state may be used for reception of the first PDSCH. In this case, the terminal device is not expected that the fourth TCI state is not associated with the target beam.

In some implementations, the fourth TCI state may be a TCI state in a set of candidate TCI states. The set of candidate TCI states may be configured using RRC or MAC CE. The terminal device may consider that a TCI state that is not associated with the target beam in the set of candidate TCI states is not a valid TCI state in the valid duration.

In some implementations, if the terminal device is configured to receive a first signal, and the TCI state corresponding to the first signal is not associated with the target beam, then the terminal device will not receive the first signal during the valid duration. The first signal may include one or more of: a PDSCH, a semi-persistent scheduling (SPS)-PDSCH, or a CSI-RS.

In some implementations, a first paging occasion configured for the terminal device is located within the valid duration. If a TCI state corresponding to the first paging occasion is not associated with the target beam, the terminal device will not monitor a paging message in the first paging occasion. Otherwise, the terminal device may monitor the paging message in the first paging occasion.

The above has described the wireless communication method provided by the embodiments of the present application in detail above from the perspective of the terminal device. The following will describe the communication method provided by the embodiments of the present application in detail from the perspective of a network device. It is to be understood that the descriptions at the network device side and the descriptions at the terminal device side correspond to each other, and redundant descriptions are omitted as appropriate for the sake of brevity.

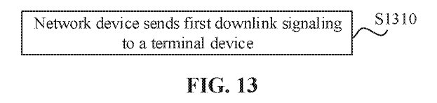

FIG. 13 is a schematic flowchart of a communication method provided by an embodiment of the present application. The method in FIG. 13 may be performed by a network device. The network device may be a network device that supports NTN functions.

Referring to FIG. 13, in operation S1310, the network device sends first downlink signaling. The first downlink signaling is used for indicating beam information. Herein, the beam information includes one or more of the following: a target beam in an active state, or a valid duration of the target beam.

In some implementations, the first downlink signaling is carried in a first DCI.

In some implementations, a start location of the valid duration is determined based on one or more of the following: a transmission duration of the first DCI, or a first offset.

In some implementations, the start location of the valid duration is determined based on a sum of an end location of the first DCI and the first offset.

In some implementations, the first offset may be in unit of symbols.

In some implementations, the start location of the valid duration is determined based on a sum of a first slot and the first offset, where the first slot corresponds to the transmission duration of the first DCI.

In some implementations, the start location of the valid duration is determined based on a sum of a start location of the first slot and the first offset; or the start location of the valid duration is determined based on a sum of an end location of the first slot and the first offset.

In some implementations, the first offset is in unit of slots.

In some implementations, the value of the first offset is determined based on one or more of the following: capability of the terminal device, a predefined value corresponding to a subcarrier spacing, or configuration information from the network device.

In some implementations, the first DCI is a group common DCI; or a PDCCH carrying the first DCI is a group common PDCCH; or a PDCCH carrying the first DCI is transmitted based on a common search space with type 3.

In some implementations, the first DCI is scrambled with a dedicated RNTI.

In some implementations, the first DCI includes one or more information fields, which have one-to-one correspondence with one or more cells. Each of the one or more information fields is used to indicate beam information of a cell corresponding to the each information field.

In some implementations, the first DCI is transmitted over one of multiple monitoring occasions, where the multiple monitoring occasions correspond to multiple transmission configuration indication (TCI) states.

In some implementations, slots corresponding to the multiple monitoring occasions are consecutive slots; or symbols corresponding to the multiple monitoring occasions are consecutive symbols.

In some implementations, the first downlink signaling is carried in a first MAC CE.

In some implementations, the first MAC CE is further used to indicate one or more of a cell identity and/or a BWP identifier.

In some implementations, a start location of the valid duration is determined based on one or more of the following: a transmission duration of the first MAC CE, a transmission duration of feedback information for the first MAC CE, or a second offset.

In some implementations, the start location of the valid duration is determined based on a first downlink slot, a slot number of the first downlink slot corresponds to a slot number of a first uplink slot, and the first uplink slot corresponds to the transmission duration of the feedback information.

In some implementations, the start location of the valid duration is determined based on a sum of the first downlink slot and the second offset.

In some implementations, the start location of the valid duration is determined based on a second downlink slot, where the second downlink slot corresponds to the transmission duration of the first MAC CE.

In some implementations, the start location of the valid duration is determined based on a sum of the second downlink slot and the second offset.

In some implementations, the method further includes that: the network device determines, according to a TCI state(s) configured for a first CORESET and the target beam, whether to perform PDCCH transmission using the first CORESET during the valid duration.

In some implementations, the operation that the network device determines, according to the TCI state(s) configured for a first CORESET and the target beam, whether to perform PDCCH transmission using the first CORESET during the valid duration, includes that: if the TCI states configured for the first CORESET are all associated with the target beam, the network device performs the PDCCH transmission using the first CORESET during the valid duration; and/or if at least one of the TCI states configured for the first CORESET is not associated with the target beam, the network device will not perform the PDCCH transmission using the first CORESET during the valid duration.

In some implementations, the operation that the network device determines, according to the TCI state(s) configured for a first CORESET and the target beam, whether to perform PDCCH transmission using the first CORESET during the valid duration, includes that: if at least one of the TCI states configured for the first CORESET is associated with the target beam, the network device performs the PDCCH transmission using the first CORESET during the valid duration; and/or if the TCI states configured for the first CORESET are all not associated with the target beam, the network device will not perform the PDCCH transmission in the first CORESET during the valid duration.

In some implementations, the operation that the network device determines, according to the TCI state(s) configured for the first CORESET and the target beam, whether to perform PDCCH transmission using the first CORESET during the valid duration, includes that: if a first TCI state configured for the first CORESET is associated with the target beam, the network device performs PDCCH transmission in the first CORESET during the valid duration; and/or if a first TCI state configured for the first CORESET is not associated with the target beam, the network device does not perform PDCCH transmission using the first CORESET during the valid duration. Herein, the first TCI state is a TCI state that is active in the TCI states configured for the first CORESET.

In some implementations, the method further includes that: if a TCI state configured for CORESET0 is not associated with the target beam, the network device does not perform PDCCH transmission using the CORESET0 during the valid duration.

In some implementations, the network device does not send first indication information during the valid duration. The first indication information is used for configuring a TCI state corresponding to a first CORESET configured for the terminal device as a TCI state not associated with the target beam.

In some implementations, the method further includes that: the network device sends a first PDSCH during the valid duration, where the first PDSCH is scheduled using a second DCI, and the second DCI indicates a fourth TCI state used for reception of the first PDSCH. The fourth TCI state is associated with the target beam.

In some implementations, the fourth TCI state is a TCI state in a set of candidate TCI states, and a TCI state that is not associated with the target beam in the set of candidate TCI states is not a valid TCI state in the valid duration.

In some implementations, the method further includes that: if the terminal device is configured to receive a first signal, and a TCI state corresponding to the first signal is not associated with the target beam, then the network device does not transmit the first signal during the valid duration. The first signal includes one or more of: a PDSCH, a SPS-PDSCH, or a CSI-RS.

In some implementations, a first paging occasion configured for the terminal device is located within the valid duration. The method further includes that: If a TCI state corresponding to the first paging occasion is not associated with the target beam, the network device does not transmit a paging message in the first paging occasion.

In some implementations, the target beam is a cell-level beam.

It is to be noted that the beam mentioned in any of the above embodiments may be replaced with a spatial domain transmission filter. It is also to be noted that the first downlink signaling may indicate an SSB index or a CSI-RS resource index, thereby indirectly indicating a target beam.

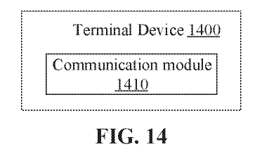

The above has described the method embodiments of the present application in detail with reference to FIGS. 1 to 13, and the following will describe the apparatus embodiments of the present application in detail with reference to FIGS. 14 to 16. It should be understood that the descriptions of the method embodiments and the descriptions of the device embodiment correspond to each other, and thus portions not described in detail may be referred to the foregoing method embodiments.

FIG. 14 is a schematic structural diagram of a terminal device provided by embodiments of the present application. The terminal device 1400 of FIG. 14 may include a communication module 1410. The communication module 1410 is configured to receive first downlink signaling. The first downlink signaling is used for indicating beam information, where the beam information includes one or more of the following: a target beam in an active state, or a valid duration of the target beam.

In some implementations, the first downlink signaling is carried in a first DCI.

In some implementations, a start location of the valid duration is determined based on one or more of the following: a transmission duration of the first DCI, or a first offset.

In some implementations, the start location of the valid duration is determined based on a sum of an end location of the first DCI and the first offset.

In some implementations, the first offset may be in unit of symbols.

In some implementations, the start location of the valid duration is determined based on a sum of a first slot and the first offset, where the first slot corresponds to the transmission duration of the first DCI.

In some implementations, the start location of the valid duration is determined based on a sum of a start location of the first slot and the first offset; or the start location of the valid duration is determined based on a sum of an end location of the first slot and the first offset.

In some implementations, the first offset is in unit of slots.

In some implementations, the value of the first offset is determined based on one or more of the following: capability of the terminal device; a predefined value corresponding to a subcarrier spacing, or configuration information from a network device.

In some implementations, the first DCI is a group common DCI; or a PDCCH carrying the first DCI is a group common PDCCH; or a PDCCH carrying the first DCI is transmitted based on a common search space with type 3.

In some implementations, the first DCI is scrambled with a dedicated RNTI.

In some implementations, the first DCI includes one or more information fields, which have one-to-one correspondence with one or more cells. Each of the one or more information fields is used to indicate beam information of a cell corresponding to each information field.

In some implementations, the first DCI is transmitted over one of multiple monitoring occasions, where the multiple monitoring occasions correspond to multiple transmission configuration indication (TCI) states.

In some implementations, slots corresponding to the multiple monitoring occasions are consecutive slots, or symbols corresponding to the multiple monitoring occasions are consecutive symbols.

In some implementations, the first downlink signaling is carried in a first MAC CE.

In some implementations, the first MAC CE is further used to indicate one or more of a cell identity and/or a BWP identifier.

In some implementations, a start location of the valid duration is determined based on one or more of the following: a transmission duration of the first MAC CE, a transmission duration of feedback information for the first MAC CE, or a second offset.

In some implementations, the start location of the valid duration is determined based on a first downlink slot, a slot number of the first downlink slot corresponds to a slot number of a first uplink slot, and the first uplink slot corresponds to the transmission duration of the feedback information.

In some implementations, the start location of the valid duration is determined based on a sum of the first downlink slot and the second offset.

In some implementations, the start location of the valid duration is determined based on a second downlink slot, where the second downlink slot corresponds to the transmission duration of the first MAC CE.

In some implementations, the start location of the valid duration is determined based on a sum of the second downlink slot and the second offset.

In some implementations, the terminal device 1410 further includes a first determination module, configured to determine, according to a TCI state(s) configured for a first CORESET and the target beam, whether to monitor a PDCCH in the first CORESET during the valid duration.

In some implementations, the first determination module is configured to: if the TCI states configured for the first CORESET are all associated with the target beam, determine to monitor the PDCCH in the first CORESET during the valid duration; and/or if at least one of the TCI states configured for the first CORESET is not associated with the target beam, determine not to monitor the PDCCH in the first CORESET during the valid duration.

In some implementations, the first determination module is configured to: if at least one of the TCI states configured for the first CORESET is associated with the target beam, determine to monitor the PDCCH in the first CORESET during the valid duration; and/or if the TCI states configured for the first CORESET are all not associated with the target beam, determine not to monitor the PDCCH in the first CORESET during the valid duration.

In some implementations, the first determination module is configured to: if a first TCI state configured for the first CORESET is associated with the target beam, determine to monitor the PDCCH in the first CORESET during the valid duration; and/or if a first TCI state configured for the first CORESET is not associated with the target beam, determine not to monitor the PDCCH in the first CORESET during the valid duration. Herein, the first TCI state is a TCI state that is active in the TCI states configured for the first CORESET.

In some implementations, the terminal device 1400 further includes a second determination module, configured to determine, according to the target beam, a TCI state that is active among the TCI states configured for the first CORESET.

In some implementations, the first CORESET is configured with a first TCI state and a second TCI state, and the first TCI state is active. The second determination module is configured to: if the first TCI state is not associated with the target beam and the second TCI state is associated with the target beam, determine the second TCI state as a TCI state that is active.

In some implementations, the TCI states configured for the first CORESET include multiple TCI states associated with the target beam, and the second TCI state is one of the following: a TCI state with the smallest index among the multiple TCI states, or a TCI state with the largest index among the multiple TCI states

In some implementations, the terminal device 1400 further include a third determination module, configured to: if a TCI state configured for CORESET0 is not associated with the target beam, determine not to monitor a PDCCH in the CORESET0 during the valid duration; or if a TCI state configured for CORESET0 is not associated with the target beam, determine a TCI state corresponding to the CORESET0 according to the target beam.

In some implementations, the third determination module is configured to: if the target beam includes one beam, determine that the CORESET0 corresponds to a third TCI state, the third TCI state being associated with the target beam; and/or if the target beam includes multiple beams, determine that the CORESET0 corresponds to a fourth TCI state, the fourth TCI state being associated with at least one of the multiple beams.

In some implementations, during the valid duration, the terminal device is not expected to receive first indication information. The first indication information is used for configuring a TCI state corresponding to a first CORESET configured for the terminal device as a TCI state not associated with the target beam.

In some implementations, the communication module 1410 is further configured to: receive a first PDSCH during the valid duration, the first PDSCH being scheduled using a second DCI, and the second DCI indicates a fourth TCI state used for reception of the first PDSCH. Herein, the terminal is not expected that the fourth TCI state is not associated with the target beam.

In some implementations, the fourth TCI state is a TCI state in a set of candidate TCI states, and a TCI state that is not associated with the target beam in the set of candidate TCI states is not a valid TCI state in the valid duration.

In some implementations, the communication module 1410 is further configured to not receive the first signal during the valid duration, if the terminal device is configured to receive a first signal, and a TCI state corresponding to the first signal is not associated with the target beam. The first signal includes one or more of: a PDSCH, a SPS-PDSCH, or a CSI-RS.

In some implementations, a first paging occasion configured for the terminal device is located within the valid duration. The terminal device further includes a fourth determination module, configured to determine not to monitor a paging message in the first paging occasion, if a TCI state corresponding to the first paging occasion is not associated with the target beam.

In some implementations, the target beam is a cell-level beam.

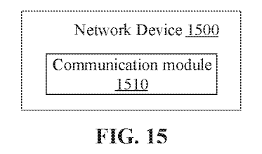

FIG. 15 is a schematic structural diagram of a network device provided by embodiments of the present application. The network device 1500 of FIG. 15 may include a communication module 1510. The communication module 1510 is configured to send first downlink signaling to a terminal device, the first downlink signaling being used for indicating beam information. Herein, the beam information includes one or more of the following: a target beam in an active state, or a valid duration of the target beam.

In some implementations, the first downlink signaling is carried in a first DCI.

In some implementations, a start location of the valid duration is determined based on one or more of the following: a transmission duration of the first DCI, or a first offset.

In some implementations, the start location of the valid duration is determined based on a sum of an end location of the first DCI and the first offset.

In some implementations, the first offset may be in unit of symbols.

In some implementations, the start location of the valid duration is determined based on a sum of a first slot and the first offset, where the first slot corresponds to the transmission duration of the first DCI.

In some implementations, the start location of the valid duration is determined based on a sum of a start location of the first slot and the first offset; or the start location of the valid duration is determined based on a sum of an end location of the first slot and the first offset.

In some implementations, the first offset is in unit of slots.

In some implementations, the value of the first offset is determined based on one or more of the following: capability of the terminal device, a predefined value corresponding to a subcarrier spacing, or configuration information from the network device.

In some implementations, the first DCI is a group common DCI; or a PDCCH carrying the first DCI is a group common PDCCH; or a PDCCH carrying the first DCI is transmitted based on a common search space with type 3.

In some implementations, the first DCI is scrambled with a dedicated RNTI.

In some implementations, the first DCI includes one or more information fields, which have one-to-one correspondence with one or more cells. Each of the one or more information fields is used to indicate beam information of a cell corresponding to each information field.

In some implementations, the first DCI is transmitted over one of multiple monitoring occasions, where the multiple monitoring occasions correspond to multiple transmission configuration indication (TCI) states.

In some implementations, slots corresponding to the multiple monitoring occasions are consecutive slots; or symbols corresponding to the multiple monitoring occasions are consecutive symbols.

In some implementations, the first downlink signaling is carried in a first MAC CE.

In some implementations, the first MAC CE is further used to indicate one or more of a cell identity and/or a BWP identifier.

In some implementations, a start location of the valid duration is determined based on one or more of the following: a transmission duration of the first MAC CE, a transmission duration of feedback information for the first MAC CE, or a second offset.

In some implementations, the start location of the valid duration is determined based on a first downlink slot, a slot number of the first downlink slot corresponds to a slot number of a first uplink slot, and the first uplink slot corresponds to the transmission duration of the feedback information.

In some implementations, the start location of the valid duration is determined based on a sum of the first downlink slot and the second offset.

In some implementations, the start location of the valid duration is determined based on a second downlink slot, where the second downlink slot corresponds to the transmission duration of the first MAC CE.

In some implementations, the start location of the valid duration is determined based on a sum of the second downlink slot and the second offset.

In some implementations, the network device further includes a first determination module, configured to determine whether to perform PDCCH transmission using the first CORESET during the valid duration, according to a TCI state(s) configured for a first CORESET and the target beam.

In some implementations, the first determination module is configured to: if the TCI states configured for the first CORESET are all associated with the target beam, determine to perform the PDCCH transmission using the first CORESET during the valid duration; and/or if at least one of the TCI states configured for the first CORESET is not associated with the target beam, determine not to perform the PDCCH transmission using the first CORESET during the valid duration.

In some implementations, the first determination module is configured to: if at least one of the TCI states configured for the first CORESET is associated with the target beam, determine to perform the PDCCH transmission using the first CORESET during the valid duration; and/or if the TCI states configured for the first CORESET are all not associated with the target beam, determine not to perform the PDCCH transmission using the first CORESET during the valid duration.

In some implementations, the first determination module is configured to: if a first TCI state configured for the first CORESET is associated with the target beam, determine to perform the PDCCH transmission using the first CORESET during the valid duration; and/or if a first TCI state configured for the first CORESET is not associated with the target beam, determine not to perform the PDCCH transmission using the first CORESET during the valid duration. Herein, the first TCI state is a TCI state that is active in the TCI states configured for the first CORESET.

In some implementations, the network device 1500 further includes a second determination module, configured to: if a TCI state configured for CORESET0 is not associated with the target beam, determine not to perform the PDCCH transmission using the CORESET0 during the valid duration.

In some implementations, the network device does not send first indication information during the valid duration. The first indication information is used for configuring a TCI state corresponding to a first CORESET configured for the terminal device as a TCI state not associated with the target beam.

In some implementations, the communication module 1510 is further configured to: send a first PDSCH during the valid duration, the first PDSCH being scheduled based on a second DCI, and the second DCI indicates a fourth TCI state used for reception of the first PDSCH. Herein, the fourth TCI state is associated with the target beam.

In some implementations, the fourth TCI state is a TCI state in a set of candidate TCI states, and a TCI state that is not associated with the target beam in the set of candidate TCI states is not a valid TCI state in the valid duration.

In some implementations, the network device 1500 further includes a third determination module, configured to: if the terminal device is configured to receive a first signal, and a TCI state corresponding to the first signal is not associated with the target beam, determine not to transmit the first signal during the valid duration. The first signal includes one or more of: a PDSCH, a SPS-PDSCH, or a CSI-RS.

In some implementations, a first paging occasion configured for the terminal device is located within the valid duration. The network device 1500 further includes a fourth determination module, configured to determine not to transmit a paging message in the first paging occasion, if a TCI state corresponding to the first paging occasion is not associated with the target beam.

In some implementations, the target beam is a cell-level beam.

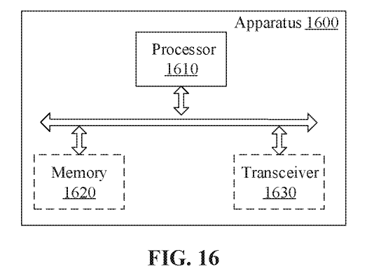

FIG. 16 is a schematic structure diagram of an apparatus provided by an embodiment of the present disclosure. The dashed line in FIG. 16 indicates that the unit(s) or module(s) is optional. The apparatus 1600 may be used to implement the method described in the above method embodiments. The apparatus 1600 may be a chip, a terminal device, or a network device.

The apparatus 1600 may include one or more processors 1610. The processor 1610 may support the apparatus 1600 to implement the method as described in the above method embodiments. The processor 1610 may be a general-purpose processor or a dedicated processor. For example, the processor may be a central processing unit (CPU). Or, the processor may also be another general purpose processor, a digital signal processor (DSP), an application specific integrated circuit (ASIC), a field programmable gate array (FPGA) or other programmable logic devices, discrete gates or transistor logic devices, or discrete hardware components. The general purpose processor may be a microprocessor or any conventional processor.

The apparatus 1600 may include one or more memories 1620. The memory 1620 ma store a program, which may be executed by the processor 1610, so that the apparatus 1600 implements the method as described in the above method embodiments. The memory 1620 may be independent of the processor 1610 or may be integrated in the processor 1610.

The apparatus 1600 may include a transceiver 1630. The processor 1610 may communicate with other devices or chips through the transceiver 1630. For example, the processor 1610 may transmit and receive data with other devices or chips through the transceiver 1630.

In an embodiment of the present disclosure, there is further provided a computer-readable storage medium for storing a program. The computer-readable storage medium may be applied to the terminal device or the network device provided by the embodiments of the present application, and the program causes a computer to execute the method performed by the terminal device or the network device in various embodiments of the present application.

In an embodiment of the present disclosure, there is further provided a computer program product. The computer program product includes a program. The computer program product may be applied to the terminal device or the network device provided by the embodiments of the present application, and the program causes a computer to execute the method performed by the terminal device or the network device in various embodiments of the present application.

In an embodiment of the present disclosure, there is further provided a computer program. The computer program may be applied to the terminal device or the network device provided by the embodiments of the present application, and the computer program causes a computer to execute the method performed by the terminal device or the network device in various embodiments of the present application.

It should be understood that in the embodiments of the present application, "B corresponding to A" means that B is associated with A, or B may be determined from A. However, it should also be understood that determining B from A does not mean that B is determined from A alone, and it may also mean that B may also be determined from A and/or other information.

It should be understood that the term “and/or” herein is merely an association relationship for describing related objects, representing that there may be three kinds of relationships. For example, A and/or B may represent the following three situations: i.e., independent existence of A, existence of both A and B, and independent existence of B. In addition, the character “/” in the present disclosure generally represents that an “or” relationship is formed between the previous and next associated objects.

It should also be understood that in various embodiments of the present application, the size of the sequence number of the above-described processes does not mean the order of execution, and the order of execution of various processes should be determined by their functions and internal logics, and should not constitute any limitation on the implementation of the embodiments of the present application.

In several embodiments provided herein, it is to be understood that the disclosed systems, apparatuses and methods may be implemented in other manners. For example, the above-described embodiments of the apparatus are only schematic, for example, the division of the units is only a logical function division, and in practice, there may be another division manner, for example, multiple units or components may be combined or integrated into another system, or some features may be ignored or not performed. In addition, the coupling or direct coupling or communication connection between each other illustrated or discussed may be indirect coupling or communication connection through some interfaces, devices or units, and may be electrical, mechanical or other form.

The units illustrated as separate elements may or may not be physically separated, and the elements displayed as units may or may not be physical units, i.e. may be located in a place, or may be distributed over a plurality of network units. Part or all of the units may be selected according to the actual needs to achieve the purpose of the embodiments of the present disclosure.

In addition, various functional units in various embodiments of the present application may be integrated in one processing unit, each unit may exist physically alone, or two or more units may be integrated in one unit.

The above embodiments may be implemented in whole or in part by software, hardware, firmware, or any combination thereof. When implemented using software, they may be implemented in whole or in part in the form of a computer program product. The computer program product includes one or more computer instructions. When the computer program instructions are loaded and executed on a computer, the processes or functions described in accordance with the embodiments of the present application are generated in whole or in part. The computer may be a general purpose computer, a dedicated computer, a computer network, or other programmable devices. The computer instructions may be stored in a computer-readable storage medium or transmitted from one computer-readable storage medium to another one. For example, the computer instructions may be transmitted from one website, computer, server or data center by wired (e.g. coaxial cable, optical fiber, digital subscriber line (DSL)) or wireless (e.g. infrared, wireless, microwave, etc.) means to another website, computer, server or data center. The computer-readable storage medium may be any available medium that can be read by a computer, or a data storage device including a server, a data center, or the like that encompasses one or more available media integrations. The available media may be magnetic media (e.g., floppy disk, hard disk, magnetic tape), optical media (e.g., digital video disc (DVD)), or semiconductor media (e.g., solid state disk (SSD)), etc.

The above is only the specific implementation of the present disclosure, but the scope of protection of the present disclosure is not limited thereto. Any person skilled in the art may easily think of changes or substitutions within the technical scope disclosed in the present disclosure, which is to be covered within the protection scope of the present disclosure. Therefore, the scope of protection of the present disclosure shall be subject to the scope of protection of the claims.

1. A wireless communication method, comprising:
receiving, by a terminal device, first downlink signaling used for indicating beam information,
wherein the beam information comprises one or more of the following:
a target beam in an active state, or
a valid duration of the target beam.

2. The method of claim 1, wherein the first downlink signaling is carried in first downlink control information (DCI),
wherein a start location of the valid duration is determined based on one or more of the following:
a transmission duration of the first DCI, or
a first offset.

3. The method of claim 2, wherein the start location of the valid duration is determined based on a sum of an end location of the transmission duration of the first DCI and the first offset; or
wherein the start location of the valid duration is determined based on a sum of a first slot and the first offset, and the first slot corresponds to the transmission duration of the first DCI.

4. The method of claim 1, wherein the first downlink signaling is carried in a first medium access control control element (MAC CE),
wherein a start location of the valid duration is determined based on one or more of:
a transmission duration of the first MAC CE,
a transmission duration of feedback information for the first MAC CE, or
a second offset.

5. The method of claim 1, further comprising:
determining, by the terminal device according to a TCI state(s) configured for a first control resource set (CORESET) and the target beam, whether to monitor a physical downlink control channel (PDCCH) in the first CORESET during the valid duration.

6. The method of claim 5, wherein determining, by the terminal device according to the TCI states configured for the first CORESET and the target beam, whether to monitor the PDCCH in the first CORESET during the valid duration, comprises at least one of:
if the TCI states configured for the first CORESET are all associated with the target beam, monitoring, by the terminal device, the PDCCH in the first CORESET during the valid duration; or
if at least one of the TCI states configured for the first CORESET is not associated with the target beam, not monitoring, by the terminal device, the PDCCH in the first CORESET during the valid duration,
or
wherein determining, by the terminal device according to the TCI state(s) configured for the first CORESET and the target beam, whether to monitor the PDCCH in the first CORESET during the valid duration, comprises at least one of:
if a first TCI state configured for the first CORESET is associated with the target beam, monitoring, by the terminal device, the PDCCH in the first CORESET during the valid duration; or
if the first TCI state configured for the first CORESET is not associated with the target beam, determining, by the terminal device, not to monitor the PDCCH in the first CORESET during the valid duration;
wherein the first TCI state is a TCI state that is active among the TCI states configured for the first CORESET.

7. The method of claim 1, further comprising:
determining, by the terminal device according to the target beam, a TCI state that is active among the TCI states configured for the first CORESET,
wherein the first CORESET is configured with a first TCI state and a second TCI state, and the first TCI state is active,
wherein determining, by the terminal device according to the target beam, the TCI state that is active among the TCI states configured for the first CORESET, comprises:
if the first TCI state is not associated with the target beam and the second TCI state is associated with the target beam, determining, by the terminal device, the second TCI state as the TCI state that is active.

8. The method of claim 1, further comprising:
if a TCI state configured for CORESET0 is not associated with the target beam, determining, by the terminal device, not to monitor a PDCCH in the first CORESET0 during the valid duration; or
if a TCI state configured for CORESET0 is not associated with the target beam, determining, by the terminal device, a TCI state corresponding to the CORESET0 according to the target beam,
wherein determining, by the terminal device, the TCI state corresponding to the CORESET0 according to the target beam comprises at least one of:
if the target beam comprises one beam, determining, by the terminal device, that the CORESET0 corresponds to a third TCI state, the third TCI state being associated with the target beam; or
if the target beam comprises a plurality of beams, determining, by the terminal device, that the CORESET0 corresponds to a fourth TCI state, the fourth TCI state being associated with at least one of the plurality of beams.

9. The method of claim 1, further comprising:
receiving, by the terminal device, a first physical downlink shared channel (PDSCH) during the valid duration, the first PDSCH being scheduled based on a second DCI, and the second DCI indicating a fourth TCI state used for reception of the first PDSCH;
wherein the terminal device is not expected that the fourth TCI state is not associated with the target beam,
wherein the fourth TCI state is a TCI state in a set of candidate TCI states, and a TCI state that is not associated with the target beam in the set of candidate TCI states is not a valid TCI state in the valid duration.

10. The method of claim 1, further comprising:
if the terminal device is configured to receive a first signal, and a TCI state corresponding to the first signal is not associated with the target beam, not receiving, by the terminal device, the first signal during the valid duration,
wherein the first signal comprises one or more of a PDSCH, a semi-persistent scheduling (SPS)-PDSCH, or a channel state information reference signal (CSI-RS).

11. A terminal device, comprising: a memory and a processor, wherein the memory is used for storing a program, and the processor is configured to invoke the program in the memory to cause the terminal device to:
receive first downlink signaling used for indicating beam information;
wherein the beam information comprises one or more of the following:
a target beam in an active state, or
a valid duration of the target beam.

12. The terminal device of claim 11, wherein the first downlink signaling is carried in first downlink control information (DCI),
wherein a start location of the valid duration is determined based on one or more of:
a transmission duration of the first DCI, or
a first offset.

13. The terminal device of claim 12, wherein
the first DCI is a group common DCI, or
a physical downlink control channel (PDCCH) carrying the first DCI is a group common PDCCH, or
a PDCCH carrying the first DCI is transmitted based on a common search space with type 3.

14. A network device, comprising: a memory and a processor, wherein the memory is used for storing a program, and the processor is configured to invoke the program in the memory to cause the network device to:
send to a terminal device first downlink signaling used for indicating beam information;
wherein the beam information comprises one or more of the following:
a target beam in an active state, or
a valid duration of the target beam.

15. The network device of claim 14, wherein the first downlink signaling is carried in first downlink control information (DCI),
wherein a start location of the valid duration is determined based on one or more of the following:
a transmission duration of the first DCI, or
a first offset.

16. The network device of claim 14, wherein the first downlink signaling is carried in a first medium access control control element (MAC CE),
wherein a start location of the valid duration is determined based on one or more of:
a transmission duration of the first MAC CE,
a transmission duration of feedback information for the first MAC CE, or
a second offset.

17. The network device of claim 14, wherein the processor is further configured to invoke the program in the memory to cause the network device to:
determine, according to a TCI state(s) configured for a first control resource set (CORESET) and the target beam, whether to perform physical downlink control channel (PDCCH) transmission using the first CORESET during the valid duration.

18. The network device of claim 17, wherein the processor is further configured to invoke the program in the memory to cause the network device to perform at least one of:
if the TCI states configured for the first CORESET are all associated with the target beam, determining to perform the PDCCH transmission using the first CORESET during the valid duration; or
if at least one of the TCI states configured for the first CORESET is not associated with the target beam, determining not to perform the PDCCH transmission using the first CORESET during the valid duration,
or
wherein the processor is further configured to invoke the program in the memory to cause the network device to perform at least one of:
if a first TCI state configured for the first CORESET is associated with the target beam, determining to perform the PDCCH transmission using the first CORESET during the valid duration; or
if the first TCI state configured for the first CORESET is not associated with the target beam, determining not to perform the PDCCH transmission using the first CORESET during the valid duration,
wherein the first TCI state is a TCI state that is active among the TCI states configured for the first CORESET.

19. The network device of claim 14, wherein the processor is further configured to invoke the program in the memory to cause the network device to:
send a first physical downlink shared channel (PDSCH) during the valid duration, the first PDSCH being scheduled based on a second DCI, and the second DCI indicating a fourth TCI state used for reception of the first PDSCH, wherein the fourth TCI state is associated with the target beam,
wherein the fourth TCI state is a TCI state in a set of candidate TCI states, and a TCI state that is not associated with the target beam in the set of candidate TCI states is not a valid TCI state in the valid duration.

20. The network device of claim 14, wherein the processor is further configured to invoke the program in the memory to cause the network device to:
determine not to transmit the first signal during the valid duration, if the terminal device is configured to receive a first signal, and a TCI state corresponding to the first signal is not associated with the target beam,
wherein the first signal comprises one or more of a PDSCH, a semi-persistent scheduling (SPS)-PDSCH, or a channel state information reference signal (CSI-RS).
